(19) United States
(12) Patent Application Publication
(10) Pub. No.: US 2011/0082742 A1
(43) Pub. Date: Apr. 7, 2011

(54) METHODS AND APPARATUS FOR ESTIMATING ADVERTISEMENT IMPRESSIONS AND ADVERTISER SEARCH SHARE

(75) Inventor: Richard Stokes, Glenview, IL (US)

(73) Assignee: ADGOOROO, LLC, Chicago, IL (US)

(21) Appl. No.: 12/726,841

(22) Filed: Mar. 18, 2010

Related U.S. Application Data
(60) Provisional application No. 61/162,064, filed on Mar. 20, 2009.

(51) Int. Cl. G06Q 30/00

(52) U.S. Cl. 705/14.45

(57) ABSTRACT

The present disclosure provides methods and apparatus for estimating advertisement impressions and advertiser search share. These estimates are improved by eliminating duplicate traffic based on similar words having similar traffic estimates. In addition, coverage is estimated for a particular advertiser keywords using statistical sampling. This coverage estimate is then used as a weighing factor when estimating traffic for an entire business category (e.g., group of keywords) by squaring the individual traffic estimates, summing the squared estimates, and then taking the square root of that sum.

### PRIORITY CLAIM

The present application claim priority to and the benefit of U.S. Provisional Patent Application Ser. No. 61/162,064 filed Mar. 20, 2009 the entire continents of which are hereby incorporated by reference.

### TECHNICAL FIELD

The present application relates in general to web based advertising and more specifically to methods and apparatus for estimating advertisement impressions and advertiser search share.

### BACKGROUND

Web based advertisements (ads) are often selected for display based on keywords entered by a user of a search engine (e.g., Google). More effective ads (e.g., ads with relatively high click-through rates) typically have a higher number of impressions and a higher search share than ineffective ads (e.g., ads with relatively low click-through rates). Accordingly, advertisers strive to produce effective ad copy (i.e., words that attract more click-throughs).

One way to measure an ad's impressions and search share is to use estimator tools supplied by search engines. However, these tools do not remove traffic redundancy or take in to account advertiser coverage.

### SUMMARY

The presently disclosed system solves this problem by eliminating duplicate traffic based on similar words having similar traffic estimates. In addition, coverage is estimated for a particular advertiser keywords using statistical sampling. This coverage estimate is then used as a weighing factor when estimating traffic for an entire business category (e.g., group of keywords) by squaring the individual traffic estimates, summing the squared estimates, and then taking the square root of that sum.

### BRIEF DESCRIPTION OF THE FIGURES

FIG. 1 is a block diagram showing one example of a network communications system for implementing the system disclosed herein.

FIG. 2 is a more detailed block diagram showing one example of a computing device.

FIG. 3 is a flowchart of an example process for estimating advertisement impressions and advertiser search share.

FIG. 4 is an example traffic estimate calculation for a keyword group.

FIG. 5 is an example traffic estimate for the keyword group based on advertiser coverage.

### DETAILED DESCRIPTION

The present disclosure provides methods and apparatus for estimating advertisement impressions and advertiser search share. These estimates are improved by eliminating duplicate traffic based on similar words having similar traffic estimates. In addition, coverage is estimated for a particular advertiser keywords using statistical sampling. This coverage estimate is then used as a weighing factor when estimating traffic for an entire business category (e.g., group of keywords) by squaring the individual traffic estimates, summing the squared estimates, and then taking the square root of that sum. Preferably, the disclosed system is realized in a network communications system.

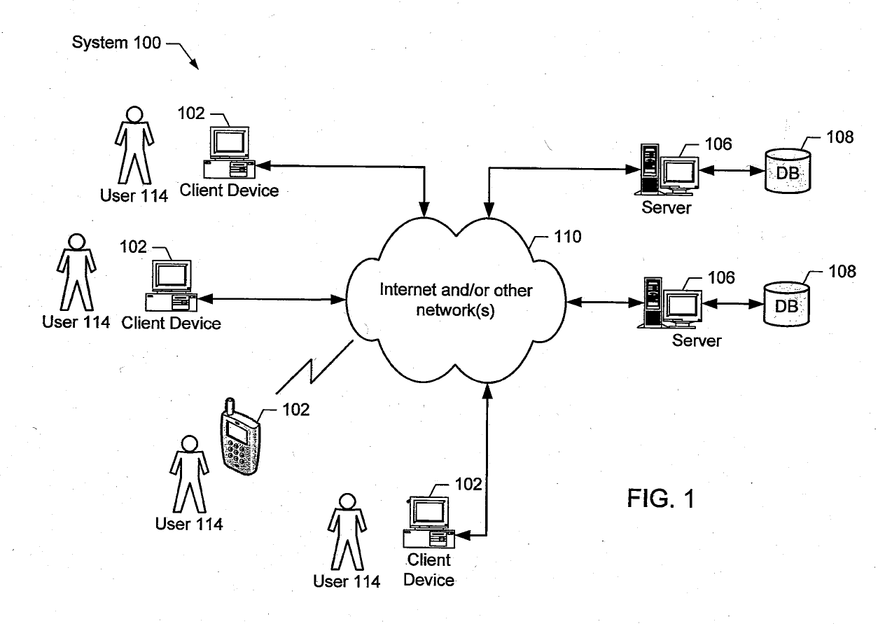

A high level block diagram of an exemplary network communications system 100 is illustrated in FIG. 1. The illustrated system 100 includes one or more client devices 102, one or more web servers 106, and one or more databases 108. Each of these devices may communicate with each other via a connection to one or more communications channels 110 such as the Internet or some other wired and/or wireless data network, including, but not limited to, any suitable wide area network or local area network. It will be appreciated that any of the devices described herein may be directly connected to each other instead of over a network.

The web server 106 stores a plurality of files, programs, and/or web pages in one or more databases 108 for use by the client devices 102. The databases 108 may be connected directly to the web server 106 and/or via one or more network connections.

One web server 106 may interact with a large number of client devices 102. Accordingly, each server 106 is typically a high end computer with a large storage capacity, one or more fast microprocessors, and one or more high speed network connections. Conversely, relative to a typical server 106, each client device 102 typically includes less storage capacity, a single microprocessor, and a single network connection.

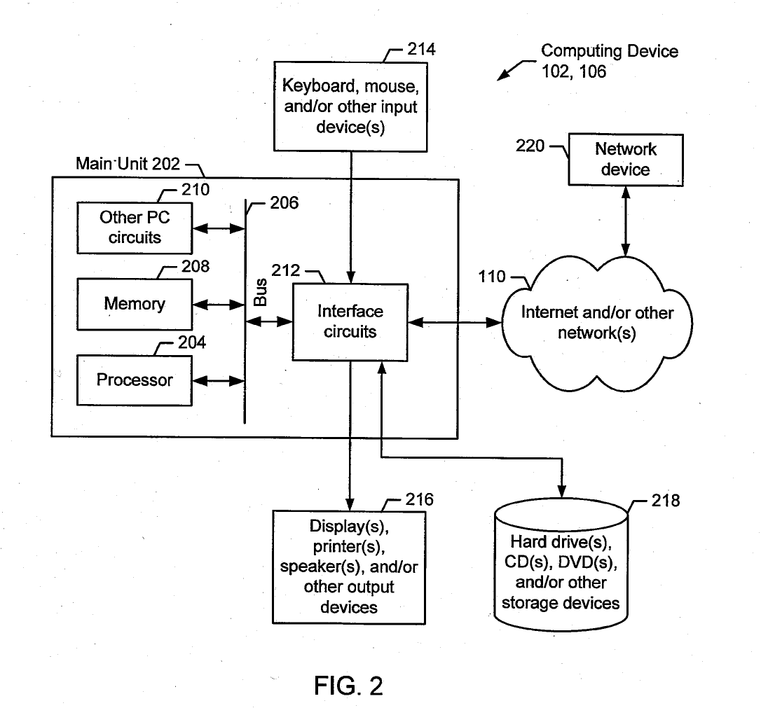

A more detailed block diagram of the electrical systems of a computing device (e.g., client device 102 and/or server 106) is illustrated in FIG. 2. Although the electrical systems of a client device 102 and a typical server 106 may be similar, the structural differences between the two types of devices are well known.

The client device 102 may include a personal computer (PC), a tablet-style computer, a personal digital assistant (PDA), an Internet appliance, a cellular telephone, or any other suitable communication device. The client device 102 includes a main unit 202 which preferably includes one or more processors 204 electrically coupled by an address/data bus 206 to one or more memory devices 208, other computer circuitry 210, and one or more interface circuits 212. The processor 204 may be any suitable processor. The memory 208 preferably includes volatile memory and non-volatile memory. Preferably, the memory 208 stores a software program that interacts with the other devices in the system 100 as described below. This program may be executed by the processor 204 in any suitable manner. The memory 208 may also store digital data indicative of documents, files, programs, web pages, etc. retrieved from a server 106 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays, printers, speakers, and/or other output devices 216 may also be connected to the main unit 202 via the interface circuit 212. The display 216 may be a cathode ray tube (CRTs), liquid crystal displays (LCDs), or any other type of display. The display 216 generates visual displays of data generated during operation of the client device 102. For example, the display 216 may be used to display web pages and/or desktop pop-up data received from the server 106. The visual displays may include prompts for human input, run time statistics, calculated values, data, etc. Stylus-sensitive displays are currently available for use with tablet computers, and such displays may be used as device 216, as discussed below.

One or more storage devices 218 may also be connected to the main unit 202 via the interface circuit 212. For example, a hard drive, CD drive, DVD drive, and/or other storage devices may be connected to the main unit 202. The storage devices 218 may store any type of data or content used by the client device 102.

The client device 102 may also exchange data with other network devices 220 via a connection to the network 110. The network connection may be any type of network connection, such as an Ethernet connection, digital subscriber line (DSL), telephone line, coaxial cable, etc. Users 114 of the system 100 may be required to register with the server 106. In such an instance, each user 114 may choose a user identifier (e.g., e-mail address) and a password which may be required for the activation of services. The user identifier and password may be passed across the network 110 using encryption built into the user's browser. Alternatively, the user identifier and/or password may be assigned by the server 106.

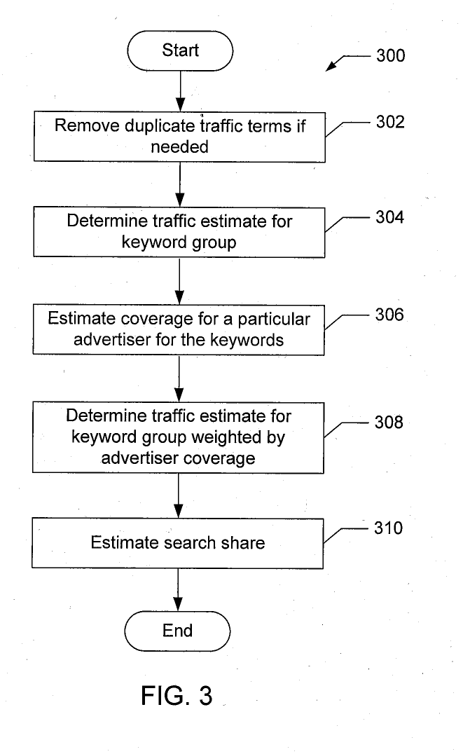

FIG. 3 shows a flowchart of an example process 300 for estimating advertisement impressions and advertiser search share. In this example, an estimate of the total search impressions in a given business category (e.g., group of keywords) is calculated. This estimate is more accurate than the naïve approach described below, because the disclosed estimation method reduces the error associated with duplicate traffic estimates for similar terms (e.g., plurals, synonyms, etc).

Some search engines remove redundant results from their prediction, others do not. In a first step 302 of the example process 300, if necessary, duplicate traffic estimates are eliminated. For example, if the keyword “dog” is reported to have 100,000 searches per month, and the keyword “dogs” is also reported to have 100,000 searches per month, then only 100,000 searches per month is attributed to this pair of terms (not 200,000). In other words, only unique traffic estimates are used to eliminate duplication of search volume common with tail-end terms. Alternatively, near duplicates based on word stems may also be eliminated. For example, if the keyword “cat” is reported to have 100,000 searches per month, and the keyword “cats” is reported to have 100,050 searches per month, then only 100,025 searches per month is attributed to this pair of terms (not 200,050).

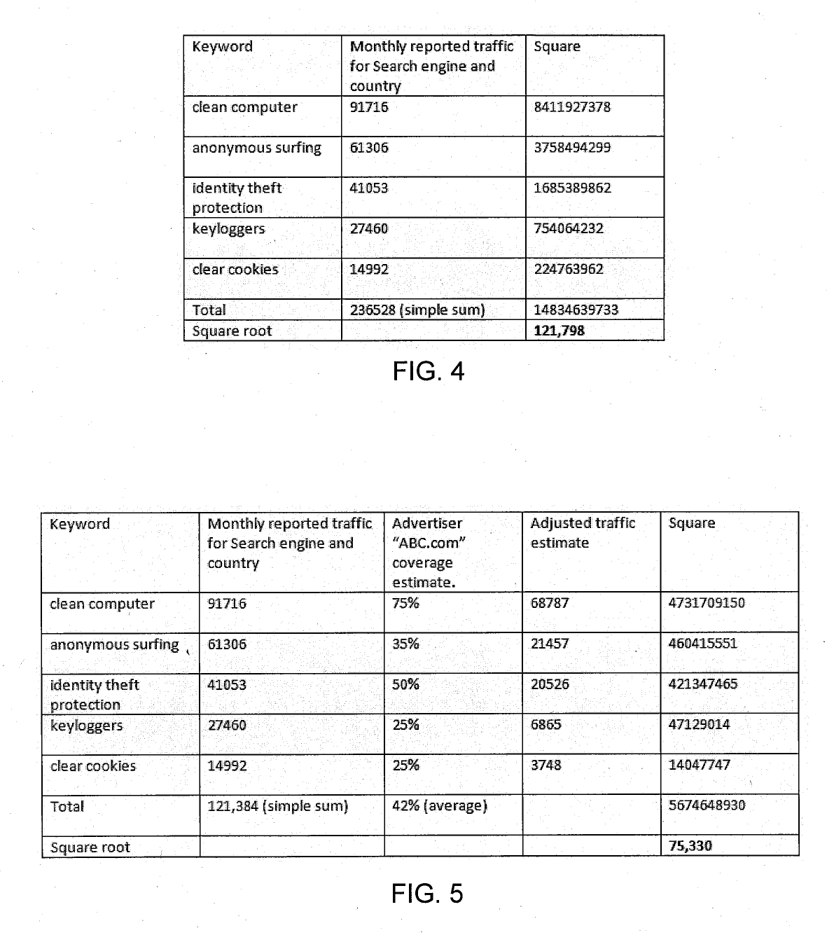

In a second step 304 of the example process 300, a traffic estimate for an entire business category (e.g., group of keywords) is determined by squaring the individual traffic estimates, summing the squared estimates, and then taking the square root of that sum. An example of this calculation is shown in FIG. 4. As a result of this step, the overall category traffic estimate is 121,798 searches per month. This is significantly less than 236,528, the simple sum of the individual traffic estimates

In a third step 306 of the example process 300, coverage is estimated for a particular advertiser for each of the keywords. This may be accomplished using statistical sampling. For example, a group of keywords may be presented to a search engine (e.g., Google) one hundred times, and the particular advertiser's ad may appear 75 times. Therefore, that advertiser's ad for that business category is estimated to be 75%.

In a fourth step 308 of the example process 300, a traffic estimate for the keyword group is determined based on advertiser coverage. In other words, the process described above in step two is repeated after multiplying the traffic estimates by the advertiser's coverage for each keyword. An example of this calculation is shown in FIG. 5. In this example, the estimate for advertiser “abc.com” traffic is 75,330 impressions per month.

In a fifth step 310 of the example process 300, the result of the fourth step 308 is divided by the result of the second step 304 to determine a search share estimate. In this example, 75,330/121,798=62%. This indicates that the given advertiser's ads are appearing across approximately 62% of all monthly searches in the assigned category. This is a much more accurate estimate than that calculated by taking an average of the advertisers' coverage for each keyword (75%, 35%, 50%, 25%, 25% . . . average is 42%).

Of course, it will be appreciated that many modifications to the above example process may be made without departing form the scope and spirit of the disclosed methods and apparatus. For example, prior to execution of a traffic correction algorithm, the system 100 may perform a normalization process on one or more business categories (e.g., keyword groups) to eliminate synonymous business categories from consideration. For example, “apple discount” and “discount apple” may be considered to be synonymous keyword groups. Accordingly, each keyword group may be sorted alphabetically prior to processing to eliminate differentiation between keyword groups based on keyword order.

In addition, certain punctuation symbols may be eliminated prior to other processing steps. For example, the system 100 may remove -(dash), & (ampersand), and ' (apostrophe) symbols. As a result, this would normalize the terms e.g. “at&t”, “a.t.t.” and “att”, all of which may have separate and identical traffic estimates provided for them.

After these normalization steps, the system 100 may perform a partial SOUNDEX on the keywords with the same traffic values to identify duplicates. SOUNDEX is a well-known algorithm which can perform fuzzy matching on short character strings. SOUNDEX typically returns a 4 character code which is specific to a given phrase. By examining only the first 1-3 characters of the SOUNDEX result, the system 100 can identify keyword phrases with similar meanings but different spellings. The following example illustrates this. In the first two cases below, a regular SOUNDEX comparison identifies the first two phrases as being similar, but not the third phrase. By comparing only the first 3 characters however, all three phrases are identified as being potentially identical in meaning

a. “Keyword tool”->SOUNDEX=K630

b. “Keyword toolset”->SOUNDEX=K630

c. “keywords tool”->SOUNDEX=K632

In addition, false positives (e.g. two words which are not actually identical, despite having similar spellings and traffic values) can be greatly reduced by looking for a shorter string within a longer string.

Any and all of the techniques disclosed herein may be used on a case-by-ase basis. The following is an example. The keyword groups “apple discounts” and “apple student discount”. are entered in to the system 100. Both of these keyword groups are reported as having 7,400 searches per month. The system 100 wants to determine if this traffic estimate is redundant, so the system 100 eliminates punctuation from both keywords (with no effect in this case). Next, the system 100 sorts the keywords. The keyword group “apple discounts” remains “apple discounts.” However, the keyword group “apple student discount” becomes “apple discount student.” The system 100 then performs SOUNDEX on both keywords groups. The “apple discounts” keyword group receives a SOUNDEX result of A140. The “apple discount student” keyword group also receives a SOUNDEX result of A140. Finally, the system 100 checks for the presence of the shorter string “apple discounts” inside of the longer string “apple discount student”. In this example, the shorter string is found in the longer string. Because of this result and/or the SOUNDEX result, a match is assumed and the final keyword traffic is discounted by 7,400 searches.

In summary, persons of ordinary skill in the art will readily appreciate that methods and apparatus for estimating advertisement impressions and advertiser search share have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

1. A method of estimating an advertiser search share, the method comprising:
receiving a keyword group including a first keyword and a second keyword, the second keyword being different that the first keyword;
receiving a first web traffic estimate associated with the first keyword;
receiving a second web traffic estimate associated with a third keyword, wherein the first keyword is a word stem of the third keyword;
determining a third web traffic estimate indicative of an average of the first web traffic estimate and the second web traffic estimate;
receiving a fourth web traffic estimate associated with the second keyword;
receiving a fifth web traffic estimate associated with a fourth keyword, wherein the second keyword is a word stem of the fourth keyword;
determining a sixth web traffic estimate indicative of an average of the fourth web traffic estimate and the fifth web traffic estimate;
squaring the third web traffic estimate to produce a first squared result;
squaring the sixth web traffic estimate to produce a second squared result;
summing the first squared result and the second squared result to produce a summed result;
determining the square root of the summed result to produce a business category web traffic estimate associated with the keyword group;
estimating a coverage associated with the keyword group for a particular advertiser;
determining a traffic estimate associated with the keyword group that is weighted by the estimated coverage; and
outputting the advertiser search share estimate associated with the keyword group and the particular advertiser by dividing the traffic estimate by the business category web traffic estimate.

2. The method of claim 1, wherein estimating coverage includes submitting the keyword group to a search engine a plurality of different times and counting a number of times that an advertisement associated with the particular advertiser appears as a result of the plurality of different search engine submissions.

3. The method of claim 1, including sorting the keyword group and another keyword group.

4. The method of claim 1, including eliminating at least one punctuation symbol from the keyword group.

5. The method of claim 1, including performing a SOUNDEX function on the keyword group and another keyword group.

6. The method of claim 1, including determining if the keyword group defines a string that is within another keyword group.

7. An apparatus for estimating an advertiser search share, the apparatus comprising:
a processor;
an input device operatively coupled to the processor;
an output device operatively coupled to the processor; and
a memory device operatively coupled to the processor, the memory device storing instructions that cause the processor, in cooperation with the input device, the output device, and the memory device, to:
receive a keyword group including a first keyword and a second keyword, the second keyword being different that the first keyword;
receive a first web traffic estimate associated with the first keyword;
receive a second web traffic estimate associated with a third keyword, wherein the first keyword is a word stem of the third keyword;
determine a third web traffic estimate indicative of an average of the first web traffic estimate and the second web traffic estimate;
receive a fourth web traffic estimate associated with the second keyword;
receive a fifth web traffic estimate associated with a fourth keyword, wherein the second keyword is a word stem of the fourth keyword;
determine a sixth web traffic estimate indicative of an average of the fourth web traffic estimate and the fifth web traffic estimate;
square the third web traffic estimate to produce a first squared result;
square the sixth web traffic estimate to produce a second squared result;
sum the first squared result and the second squared result to produce a summed result;
determine the square root of the summed result to produce a business category web traffic estimate associated with the keyword group;
estimate a coverage associated with the keyword group for a particular advertiser;
determine a traffic estimate associated with the keyword group that is weighted by the estimated coverage; and
output the advertiser search share estimate associated with the keyword group and the particular advertiser by dividing the traffic estimate by the business category web traffic estimate.

8. The apparatus of claim 7, wherein estimating coverage includes submitting the keyword group to a search engine a plurality of different times and counting a number of times that an advertisement associated with the particular advertiser appears as a result of the plurality of different search engine submissions.

9. The apparatus of claim 7, wherein the instructions cause the processor to sort the keyword group and another keyword group.

10. The apparatus of claim 7, wherein the instructions cause the processor to eliminate at least one punctuation symbol from the keyword group.

11. The apparatus of claim 7, wherein the instructions cause the processor to receive a SOUNDEX result associated with the keyword group and another keyword group.

12. The apparatus of claim 7, wherein the instructions cause the processor to determine if the keyword group defines a string that is within another keyword group.

13. A computer readable memory device storing instructions to cause a computer to:
receive a keyword group including a first keyword and a second keyword, the second keyword being different that the first keyword;
receive a first web traffic estimate associated with the first keyword;
receive a second web traffic estimate associated with a third keyword, wherein the first keyword is a word stem of the third keyword;
determine a third web traffic estimate indicative of an average of the first web traffic estimate and the second web traffic estimate;
receive a fourth web traffic estimate associated with the second keyword;
receive a fifth web traffic estimate associated with a fourth keyword, wherein the second keyword is a word stem of the fourth keyword;
determine a sixth web traffic estimate indicative of an average of the fourth web traffic estimate and the fifth web traffic estimate;
square the third web traffic estimate to produce a first squared result;
square the sixth web traffic estimate to produce a second squared result;
sum the first squared result and the second squared result to produce a summed result;
determine the square root of the summed result to produce a business category web traffic estimate associated with the keyword group;
estimate a coverage associated with the keyword group for a particular advertiser;
determine a traffic estimate associated with the keyword group that is weighted by the estimated coverage; and
output a search share estimate associated with the keyword group and the particular advertiser by dividing the traffic estimate by the business category web traffic estimate.

14. The computer readable memory device of claim 13, wherein estimating coverage includes submitting the keyword group to a search engine a plurality of different times and counting a number of times that an advertisement associated with the particular advertiser appears as a result of the plurality of different search engine submissions.

15. The computer readable memory device of claim 13, wherein the instructions cause the computer to sort the keyword group and another keyword group.

16. The computer readable memory device of claim 13, wherein the instructions cause the computer to eliminate at least one punctuation symbol from the keyword group.

17. The computer readable memory device of claim 13, wherein the instructions cause the computer to receive a SOUNDEX result associated with the keyword group and another keyword group.

18. The computer readable memory device of claim 13, wherein the instructions cause the computer to determine if the keyword group defines a string that is within another keyword group.
